(19) United States
(12) Patent Application Publication
(10) Pub. No.: US 2011/0286654 A1
(43) Pub. Date: Nov. 24, 2011

(54) Segmentation of Biological Image Data

(75) Inventor: Sriram Krishnan, Exton, PA (US)

(73) Assignee: SIEMENS MEDICAL SOLUTIONS USA, INC., Malvern, PA (US)

(21) Appl. No.: 13/109,457

(22) Filed: May 17, 2011

Related U.S. Application Data
(60) Provisional application No. 61/347,002, filed on May 21, 2010.

(51) Int. Cl. G06K 9/00

(52) U.S. Cl. 382/133; 382/128

(57) ABSTRACT

Described herein are systems and methods for automated segmentation of image data. According to one aspect of the present technology, systems and methods are provided for detecting regions of interest within biological images. In particular, first and second images of first and second biological samples are received, wherein one or more routine stains have previously been applied to the first biological sample. A region of interest in the first image may be segmented to generate a boundary. The boundary may then be transferred to the second image to segment a corresponding region of interest in the second image.

### CROSS-REFERENCE TO RELATED APPLICATION

The present application claims the benefit of U.S. provisional application No. 61/347,002 filed May 21, 2010, the entire contents of which are herein incorporated by reference.

### TECHNICAL FIELD

The present disclosure generally relates to the field of image analysis. More specifically, the present disclosure relates to image segmentation systems and methods.

### BACKGROUND

The expression of biologically relevant features (e.g., type, size, and density of cells) often forms the basis of diagnosis and treatment. Typically, a trained pathologist is provided a patient sample and assigned the diagnostic task of visually locating and discriminating cells or cellular nuclei, summing up visible cues within a microscopic tissue image and providing diagnostic information based on such observations. Such manual visual diagnosis relies heavily on the capacity of the pathologist to observe and discriminate elements one from another.

To facilitate the diagnostic process, it is often desirable to provide automated or semi-automated image processing and visual identification instruments capable of accurately detecting and quantifying the relationship between features present in imaged biological tissues. Such instruments may be used for research or screening applications. An example of the latter application is the screening for cervical cancer using the Papanicolou stain test (or Pap test). These instruments acquire and analyze digital images to locate cells of interest or to classify slides containing the tissue as being normal or suspect.

However, recognition of features within digitized medical images presents multiple challenges. For example, a first area of concern relates to the accuracy of recognition of the features within an image. A second area of concern is the speed of recognition. Because medical images are an aid for a doctor in diagnosing a disease or medical condition, the speed with which an image can be processed and features within that image can be recognized are of the utmost importance to the doctor in reaching an early diagnosis. Hence, there is a need for improving recognition techniques that provide accurate and fast recognition of anatomical features and possible abnormalities in medical images.

Currently-known techniques for image segmentation are often complex and time consuming. These techniques do not always yield high accuracy in the segmentation process, particularly if there is little contrast between the feature to be located and the background surrounding it. Consequently, current segmentation algorithms often fail to locate features properly. In cell image analysis, for example, a cell nucleus may be incorrectly segmented because the located boundary is too large or too small. This can result in false positive events (i.e. incorrectly classifying a normal feature as a suspicious feature) or false negative events (i.e. missing a true suspicious feature).

Therefore, there is a need for improved segmentation for automated imaging and automated imaging devices, and in particular, for accurate identification of feature boundaries.

### SUMMARY

The present disclosure describes a technology for automated or semi-automated segmentation of image data. According to one aspect of the present disclosure, systems and methods are provided for detecting regions of interest within biological images. In particular, first and second images of first and second biological samples are received, wherein one or more routine stains have previously been applied to the first biological sample. A region of interest in the first image may be segmented to generate a boundary. The boundary may then be transferred to the second image to segment a corresponding region of interest in the second image.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings. Furthermore, it should be noted that the same numbers are used throughout the drawings to reference like elements and features.

FIG. 1 shows an exemplary system according to an aspect of the present disclosure.

FIG. 2 shows an exemplary segmentation method according to an aspect of the present disclosure.

FIG. 3 shows an exemplary first image of a first biological sample according to an aspect of the present disclosure.

FIG. 4 shows an exemplary user interface presenting first and second images according to an aspect of the present disclosure.

FIG. 5 shows another exemplary user interface presenting first and second images according to an aspect of the present disclosure.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulate and transform data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

As used herein, the term “image” refers to multi-dimensional data composed of discrete image elements (e.g., pixels for 2D images and voxels for 3D images). The image may be, for example, a medical image of a biological sample collected by a microscopy scanner, a line scanning device, a conventional camera, a scanner, a cytometry device, a cell imaging platform, high content imaging devices and/or cell separation device, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2D picture or a 3D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

As used herein, the term “biological sample” refers to a sample obtained from a biological subject, including a sample of biological tissue or fluid origin obtained in vivo or in vitro. Such samples can be, but are not limited to, body fluid (e.g., blood, blood plasma, serum, or urine), organs, tissues, fractions, and cells isolated from mammals including, humans. Biological samples also may include sections of the biological sample including tissues (e.g., sectional portions of an organ or tissue). In addition, biological samples may further include extracts from a biological sample, for example, an antigen from a biological fluid (e.g., blood or urine). A biological sample may be of prokaryotic origin or eukaryotic origin (e.g., insects, protozoa, birds, fish, reptiles). In some embodiments, the biological sample is mammalian (e.g., rat, mouse, cow, dog, donkey, guinea pig, or rabbit). In certain embodiments, the biological sample is of primate origin (e.g., example, chimpanzee, or human). A biological sample may include any sample regardless of its physical condition, such as, but not limited to, being frozen or stained or otherwise treated. In some embodiments, a biological sample may include compounds which are not naturally intermixed with the sample in nature such as preservatives, anticoagulants, buffers, fixatives, nutrients, antibiotics, or the like.

The following description sets forth one or more implementations of systems and methods that facilitate segmentation of biological image data. In one implementation, the biological image data includes images of biological samples to which a special stain, such as immunocytochemistry (ICC), immunohistochemistry (IHC) or in-situ hybridization (ISH), has been applied. Such special stains may be useful for detecting the presence of specific tissue (e.g., peptides or protein antigens), but typically do not enhance the appearance of regions of interest sufficiently to facilitate accurate segmentation of the image. The identification of the appropriate regions of interest is critical in, for example, the case of cancer, where the region of interest must be drawn carefully to include the lesion or tumor.

The present disclosure presents a framework for automatically identifying the appropriate region of interest in biological images. Such images may be of unstained biological samples or biological samples to which special stains have been applied. In one implementation, the present framework provides accurate segmentation of an image of such biological samples by using the segmentation results of another image of a biological sample to which a routine stain (e.g., hematoxylin and eosin stain) has been applied. The resulting segmented image can be used as an input to a pre-processing step for quantification or other image processing.

It is to be understood that embodiments of the present invention can be implemented in various forms of hardware, software, firmware, special purpose processes, or a combination thereof. In one embodiment, the present technology can be implemented in software as an application program tangibly embodied in a non-transitory computer readable medium. The application program can be uploaded to, and executed by, a machine comprising any suitable architecture. The system and method of the present disclosure may be implemented in the form of a software application running on a computer system, for example, a laptop, personal computer (PC), workstation, client device, mini-computer, storage system, handheld computer, server, mainframe computer, dedicated digital appliance, and so forth. The software application may be stored in a non-transitory recording media locally accessible by the computer system and accessible via a hard wired or wireless connection to a network, for example, a local area network, or the Internet.

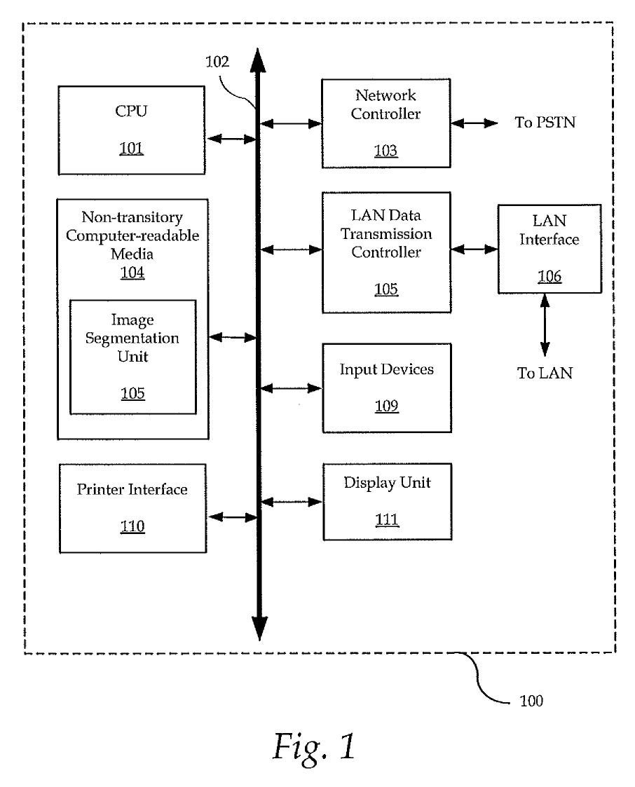

FIG. 1 shows an example of a computer system which may implement a method and system of the present disclosure. The computer system referred to generally as system 100 may include, inter alga, a central processing unit (CPU) 101, a non-transitory computer readable media 104, a printer interface 110, a display unit 111, a local area network (LAN) data transmission controller 105, a LAN interface 106, a network controller 103, an internal bus 102, and one or more input devices 109, for example, a keyboard, mouse, tablet, touch-screen, etc.

The non-transitory computer-readable media 104 can include random access memory (RAM), read only memory (ROM), magnetic floppy disk, disk drive, tape drive, flash memory, etc., or a combination thereof. The present invention may be implemented as an image segmentation unit 105 that includes computer-readable program code tangibly embodied in the non-transitory computer-readable media 104 and executed by the CPU 101. As such, the computer system 100 is a general purpose computer system that becomes a specific purpose computer system when executing the routine of the present invention. The computer-readable program code is not intended to be limited to any particular programming language and implementation thereof. It will be appreciated that a variety of programming languages and coding thereof may be used to implement the teachings of the disclosure contained herein.

The system 100 may also include an operating system and micro instruction code. The various processes and functions described herein can either be part of the micro instruction code or part of the application program or routine (or combination thereof) which is executed via the operating system. In addition, various other peripheral devices, such as an additional data storage device, a printing device and an imaging device, can also be connected to the computer platform. The imaging device may be, for example, a microscopy scanner, a line scanning device, a conventional camera, a scanner, a cytometry device, a cell imaging platform, high content imaging devices and/or cell separation device (e.g., a flow cytometry device or cell picking device). The image segmentation unit 105 may be executed by the CPU 101 to process digital image data (e.g., microscopy images) acquired by the imaging device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

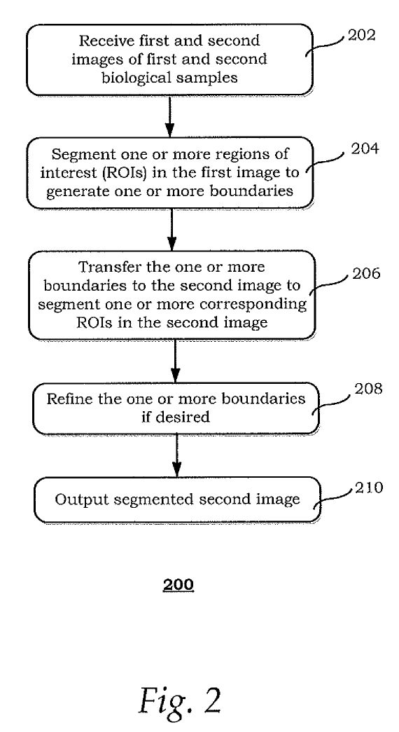

FIG. 2 shows an exemplary method 200 of segmentation in accordance with one implementation of the present framework. The exemplary method 200 may be implemented by the image segmentation unit 105 in the computer system 100, which has been previously described with reference to FIG. 1.

At 202, first and second images of first and second biological samples are received. In one implementation, the images include digitized microscopic images. Such images may be acquired by scanning a transparent slide, dish or substrate containing the respective biological sample. In one implementation, the first and second biological samples are histological samples that include cellular material (e.g., healthy or abnormal cells). Examples of biological samples include, but are not limited to, a tissue sample, a tissue section, a tissue microarray, a cultured cell, a cell suspension, a biological fluid specimen, a biopsy sample, a whole cell, a cell constituent, a cytospin, a cell smear, etc. In one implementation, the first and second biological samples are derived from the same subject at around the same time. The biological samples may be derived from the same source in the subject's body, such as the brain, cervix, lung, blood vessel, bone marrow, cartilage, lymph node, spine, breast, colon, prostate, etc. In addition, the first and second biological samples may be the same biological sample before and after application of one or more stains. In other words, the first biological sample may be treated with a routine stain, while the second biological sample is unstained. Alternatively, different stains may be applied to the first and second biological samples, as will be discussed below.

In one implementation, the first biological sample is previously treated with one or more routine stains for enhancing the appearance of cells prior to acquiring the first image of the first biological sample. The term “routine stains” as used herein refers to non-special stains that enhance the anatomical structure of the tissue. For example, a hematoxylin and eosin (H&E) stain may be applied to the first biological sample to enhance the appearance of the cells. The H&E staining method usually involves the application of hematoxylin, followed by counterstaining with eosin. Hematoxylin contains the active dye hematein that causes nucleic acids (e.g., chromatin in the cell nuclei, ribosomes, etc.) to turn blue-purple in color, while eosin colors eosinophilic structures (e.g., cytoplasm, collagen, muscle fibers, extracellular structures, red blood cells, etc.) in a variety of colors (e.g., red, pink, orange, etc.) Such routine stain may be applied to the first biological sample during or after the initial proportion of a microscopic slide. Depending on the composition of the first biological sample, the resulting first image may display a combination of various hues and shades of the two stains. Such routine stains cause the region of interest (ROI) to appear more distinct, such that the boundary delineating the ROI can be easily extracted in the segmentation step 204.

In one implementation, the second biological sample is previously treated with one or more special stains. Alternatively, the second biological sample is unstained. The term “special stains” as used herein refers to stains that identify suspected pathogens or demonstrate specific cellular components to aid pathologists in the evaluation of a disease state. Such special stains are typically monoclonal antibodies that are raised against specific proteins (e.g., antigens) and amplified by cloning. The antibodies may be labeled with a marker that stains with a brown or red counterstain. Exemplary special staining techniques include, but are not limited to, immunocytochemistry (ICC), immunohistochemistry (IHC), in-situ hybridization (ISH), histochemistry, immunofluorescence, cytochemistry, and so forth. Depending on the tissue which is stained, the resulting stain localizes the proteins in tissues or cells, and can be used to form a diagnosis or confirm an initial impression. For example, immunocytochemistry can be used to target specific peptides or protein antigens in the cell via specific epitopes, and allows the pathologist to quantify the distribution of proteins, colocalization and other properties. Although such special stains are useful for evaluating whether the cells in the biological sample express the protein antigen in question, they typically do not result in a clear contrast between the ROI and the background.

At 204, one or more regions of interest (ROIs) in the first image are segmented to generate one or more boundaries delineating the ROIs. A region of interest (ROI) refers to an area in the image is being identified for further study. The ROI may correspond to one or more features that are present in only a subset of the components of the biological sample. Such features include, but are not limited to, one or more cells, clusters of cells, cell proteins (e.g., antigens), cell membranes, cell nuclei, cell surface molecules or markers, etc., that are associated with an anatomical abnormality (e.g., tumor or lesion). The segmentation process automatically classifies pixels in the image as being associated with the ROI. For example, the image may be partitioned to distinguish the features from other biological structures within the image.

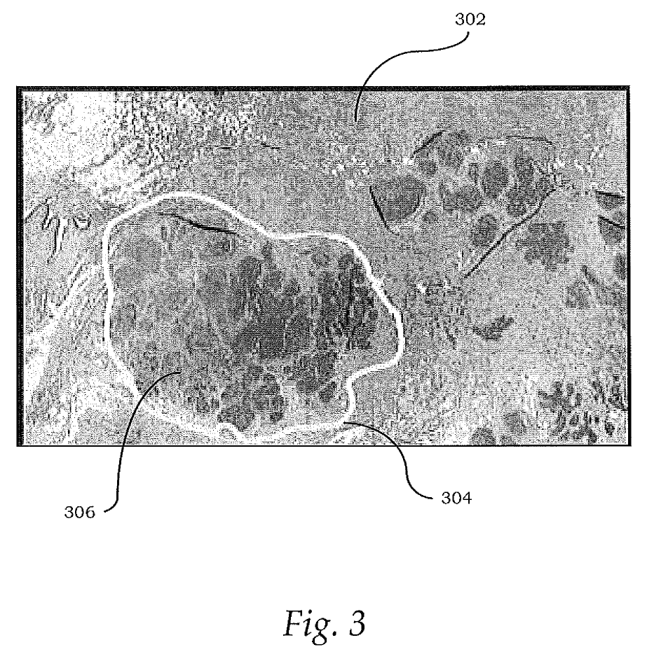

FIG. 3 shows an exemplary first image 302 of a first biological sample. Prior to scanning the image, an H&E stain was applied to the first biological sample to enhance the appearance of the cells. The H&E staining resulted in a clear nuclear staining of the tumor in the ROI 306. Due to the sharp contrast between the tumor and background, a segmentation algorithm can easily be applied to generate an accurate boundary 304 delineating the ROI 306.

Various types of segmentation or image processing algorithms may be used to automatically generate the boundary 304. One such technique involves “thresholding,” as will be described in more detail later It should be understood, however, that other automatic or semi-automatic segmentation or image processing techniques, such as region growing, clustering, compression-based, histogram-based methods, edge detection, split-and-merge, partial differential equation-based techniques, multi-scale segmentation, graph partitioning, model-based segmentation, watershed transformation, etc., may also be employed. Alternatively, a user interface may be provided to enable the user to interactively specify the boundary or identify an initial ROI.

In the thresholding technique, a threshold value of intensity may be selected, and each pixel in the image may then be compared with this threshold value for classification. For example, pixels with intensities above the threshold value may be classified as background pixels, while pixels with intensities below the threshold value are classified as ROI pixels. The threshold value for locating ROIs may be selected based on an image histogram, which is a frequency distribution of the intensities found within an image. A thresholding algorithm may find one or more threshold values using these histograms. For instance, the threshold value may be half-way between the darkest and lightest pixels. Alternatively, the threshold value may be at the inflection point between the abundant “background” pixels and the rarer “object” pixels. Once the threshold value is chosen and the thresholding process is completed, the ROI pixels can form a binary mask of the ROIs in the image. A boundary around the mask may then be used to represent each ROI.

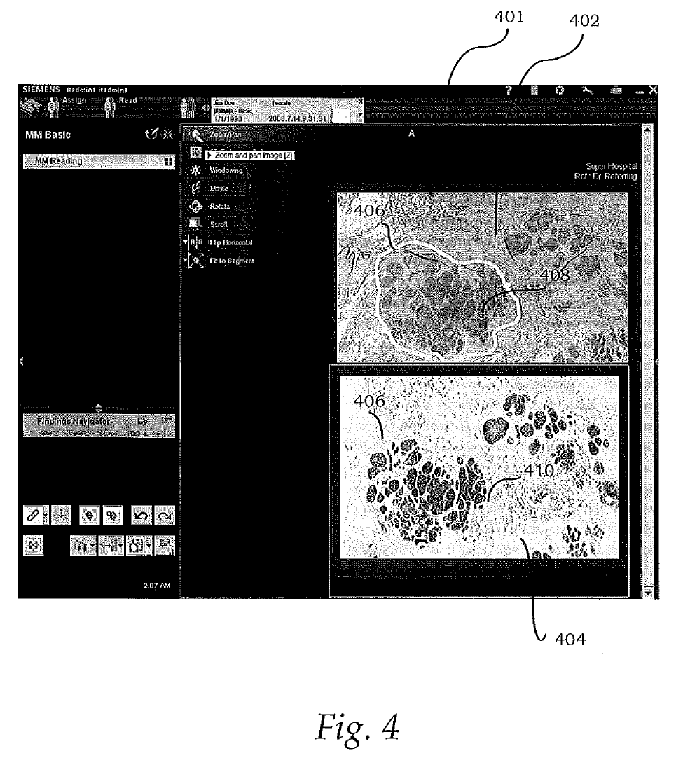

At step 206, the one or more boundaries derived from the first image are transferred to the second image to segment one or more corresponding ROIs in the second image. FIG. 4 shows an exemplary user interface 401 presenting exemplary first and second images (402 and 404). The first image 402 is of a first biological sample that has been treated with a routine stain, while the second image 404 is of a second biological sample that has previously been treated with a special stain. Since the ROI 408 is highly distinct from the background pixels, the first image 402 can be easily segmented by performing a segmentation technique that generates a boundary 406 around the ROI 408. The same boundary 406 is transferred to the second image 404 to segment the corresponding ROI 410. Accordingly, without having to perform the segmentation technique directly on the second image 404, a very accurate characterization of the tumor in the ROI 410 is obtained by using the segmentation results from the first image 402.

Prior to transferring the one or more boundaries, the corresponding ROIs in the first and second images may be correlated to minimize segmentation errors. The correlation may be performed automatically or manually so as to determine the initial placement of the boundaries in the second image. This may be achieved by performing a global matching between the first and second images and computing a transformation to align the boundaries (or ROIs). For example, if the second image is found to have shifted and rotated relative to the first image, a transformation matrix may be computed to apply the same translation and rotation to the boundaries before transferring them to the second image. It should be understood that other types of transformations may also be applied.

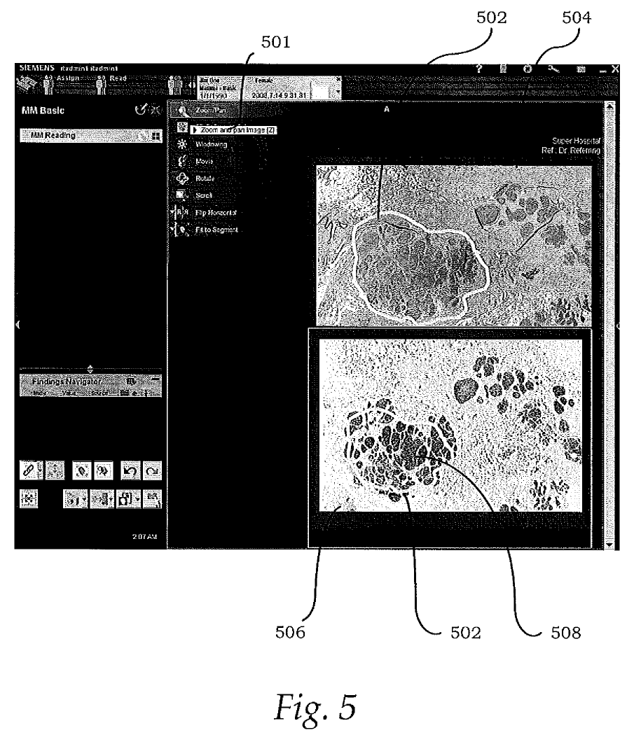

If desired, the method 200 may include an optional step 208 of refining the boundary to compensate for any inaccuracy in the segmentation of the second image after transferring the one or more boundaries. For example, FIG. 5 shows an exemplary user interface 501 presenting exemplary first and second images (504 and 506). As shown, the boundary 502 derived from the first image 504 can be reduced in size in the second image 506 to ensure that the boundary 502 accurately delineates the tumor region 508. Alternatively, if desired, the ROT may be automatically, semi-automatically or manually rotated, translated, scaled, or otherwise transformed to achieve accurate segmentation.

Once the boundary is transformed, further fine-tuning may be performed. This can be achieved either automatically or manually. To automatically refine the border, one or more morphological operations may be performed. A non-limiting example of such refinement technique includes the iterative, linear segmentation routine described in D. M. Catarious, Jr., A. H. Baydush, and C. E. Floyd, Jr., “Incorporation of an iterative, linear segmentation routine into a mammographic mass CAD system,” Med. Phys. 31, 1512-1520, 2004, which is herein incorporated by reference. Other methods may use, for example, darkness information near the boundary, or constraints such as gradient, curvature, “closeness to a circle,” etc. to refine the boundary. Alternatively, a graphical user interface 501 may be provided to allow the user to manually edit the boundary 502. The user may re-size, shift, rotate, or otherwise transform the boundary through the use of an input device. For instance, the user may click and drag the boundary in the image by using a mouse, keyboard, touch-screen or any other input device.

At 210, the segmented second image is output by the system 100. The segmented second image may be stored in a memory device for quick viewing at a later time. Alternatively, or in combination thereof, the segmented image may be rendered and displayed immediately on, for example, display unit 111. The segmented image may be viewed by a user to edit or verify, for example, the accuracy of the segmentation. In addition to viewing, the segmented image may be stored in a memory device and used for further image processing and analysis. For example, a quantification technique may be applied to the segmented image to measure one or more characteristics (e.g., size of ROIs, number of cells in ROIs, etc.).

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

Further, although method or process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

1. A system for segmenting biological image data, comprising:
a memory device for storing non-transitory computer readable program code; and
a processor in communication with the memory device, the processor being operative with the computer readable program code to:
(i) receive a first image of a first biological sample previously treated with one or more routine stains and a second image of a second biological sample;
(ii) segment one or more regions of interest in the first image to generate one or more boundaries delineating the one or more regions of interest; and
(iii) transfer the one or more boundaries to the second image to segment one or more corresponding regions of interest in the second image.

2. The system of claim 1 wherein the first and second biological samples comprise one or more abnormal cells.

3. The system of claim 1 wherein the first and second biological samples comprise a tissue sample, a tissue section, a tissue microarray, a cultured cell, a cell suspension, a biological fluid specimen, a biopsy sample, a whole cell, a cell constituent, a cytospin, or a cell smear.

4. The system of claim 1 wherein the one or more routine stains comprise hemotoxylin and eosin.

5. The system of claim 1 wherein the second biological sample is unstained.

6. The system of claim 5 wherein the one or more routine stains comprise hemotoxylin and eosin.

7. The system of claim 1 wherein the second biological sample is previously treated with a special stain.

8. The system of claim 7 wherein the special stain comprises a stain applied by immunocytochemistry, immunohistochemistry, in-situ hybridization, histochemistry, immunofluorescence or cytochemistry.

9. The system of claim 7 wherein the one or more routine stains comprise hemotoxylin and eosin.

10. The system of claim 1 wherein the first and second images comprise color images.

11. The system of claim 1 wherein the processor is further operative with the computer readable program code to segment the one or more regions of interest by performing a thresholding technique.

12. The system of claim 1 wherein the processor is further operative with the computer readable program code to correlate the corresponding regions of interest in the second image with the one or more regions of interest in the first image to minimize segmentation errors.

13. The system of claim 1 wherein the processor is further operative with the computer readable program code to refine the one or more boundaries to compensate for any inaccuracy in segmentation.

14. The system of claim 13 wherein the processor is further operative with the computer readable program code to refine the one or more boundaries by rotating, translating or scaling the one or more boundaries.

15. The system of claim 13 wherein the processor is further operative with the computer readable program code to provide a user interface to receive user input for editing the one or more boundaries.

16. The system of claim 13 wherein the processor is further operative with the computer readable program code to refine the one or more boundaries by performing one or more morphological operations on the one or more boundaries.

17. The system of claim 1 further comprising a display device for presenting the segmented second image.

18. The system of claim 1 wherein the processor is further operative with the computer readable program code to perform a quantification technique based on the segmented second image to measure one or more characteristics.

19. A non-transitory computer readable medium embodying a program of instructions executable by machine to perform steps for segmenting biological image data, the steps comprising:
(i) receiving a first image of a first biological sample previously treated with one or more routine stains and a second image of a second biological sample;
(ii) segmenting one or more regions of interest in the first image to generate one or more boundaries delineating the one or more regions of interest; and
(iii) transferring the one or more boundaries to the second image to segment one or more corresponding regions of interest in the second image.

20. A method of segmenting biological image data using a computer system, the method comprising:
(i) receiving a first image of a first biological sample previously treated with one or more routine stains and a second image of a second biological sample;
(ii) segmenting one or more regions of interest in the first image to generate one or more boundaries delineating the one or more regions of interest; and
(iii) transferring the one or more boundaries to the second image to segment one or more corresponding regions of interest in the second image.
